(19) United States
(12) Patent Application Publication
(10) Pub. No.: US 2006/0158622 A1
(43) Pub. Date: Jul. 20, 2006

(54) Single walled carbon nanotube doped microdisplay for projection display systems

(76) Inventors: Achintya K. Bhowmik, Milpitas, CA (US); Shida Tan, Milpitas, CA (US)

Correspondence Address: TROP PRUNER & HU, PC, 8554 KATY FREEWAY, SUITE 100, HOUSTON, TX, 77024, US

(21) Appl. No.: 11/037,853

(22) Filed: Jan. 18, 2005

(51) Int. Cl. G03B 21/00

(52) U.S. Cl. 353/122; 349/5

(57) ABSTRACT

A liquid crystal-on-silicon imager for a rear or a front projector may be formed with liquid crystal material doped with single walled carbon nanotubes. As a result, the switching speed may be enhanced and the drive voltage may be lowered in some embodiments.

### BACKGROUND

This invention relates generally to projection display systems, particularly, to the rear projection televisions and front projectors. The projection display systems use one or more microdisplays to create the image.

In some embodiments, the microdisplay may be formed using a liquid crystal-on-silicon (LCOS) imager. Liquid crystal-on-silicon microdisplays have better resolution than other microdisplay technologies. However, the major limitations of the liquid-crystal based display technologies are lower switching speed and higher drive current. The lower on/off speed prevents implementation of cost effective one panel optical engines at the required field and frame rates. The high operating voltage increases power dissipation complicating the thermomechanical design.

Thus, there is a need for ways to make microdisplay imagers based on liquid crystal materials with enhanced switching speed and/or lower drive voltage.

### BRIEF DESCRIPTION OF THE DRAWINGS

FIG. 1 is a schematic depiction of one embodiment of the present invention;

FIG. 2 is a schematic depiction of a rear projection display using the imager of FIG. 1; and

FIG. 3 is a schematic depiction of an electrical system for the embodiment of FIG. 2.

### DETAILED DESCRIPTION

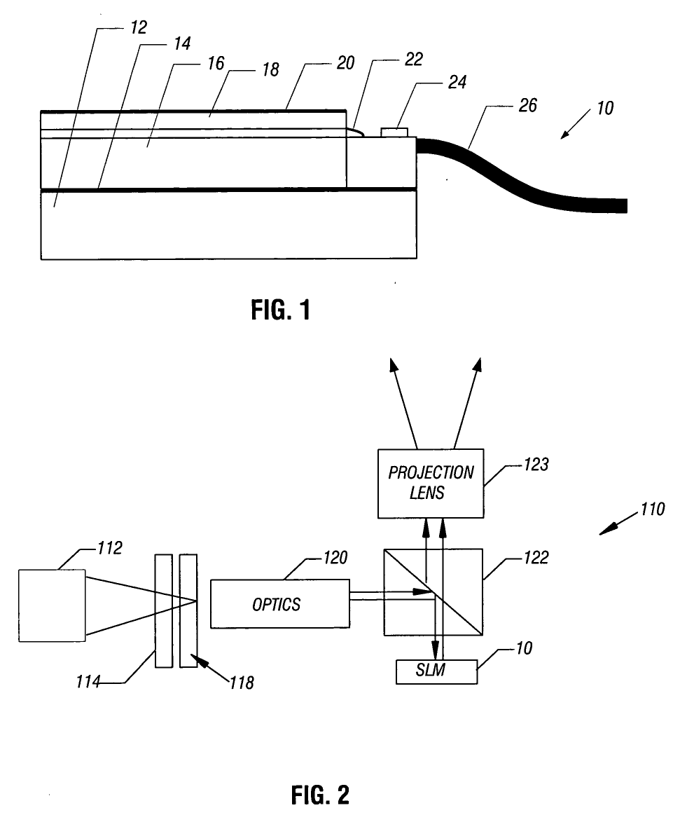

Referring to FIG. 1, a microdisplay imager 10 includes a substrate 12 for thermal management and mechanical assembly. The substrate 12 may be formed of ceramics in one embodiment. A thermal interface material (TIM) 14 is positioned over the substrate 12. Over the thermal interface material 14 is a silicon back plane 16. The back plane 16 includes drive transistors to drive each pixel of the display. Thus, each pixel may be driven to be either more or less reflective or more or less transmissive to modulate the resulting image. In addition, the back plane 16 may include an array of memory cells which act as frame buffers.

Over the back plane 16 is the liquid crystal material 18. It may be sandwiched between a pair of plates, including an upper or top electrode 20 and a lower or bottom electrode formed by the silicon back plane 16. The liquid crystal material 18 is doped with single walled carbon nanotubes. The transparent top electrode 20 may be a glass plate or other transparent sheet coated with indium tin oxide.

Wire bonds 22 are formed as indicated to the silicon back plane 16 and to surface mounted electronic components 24. A flex cable 26 enables external connections to the drive electronics board.

The electro-optically active liquid crystal material 18 is lightly doped with single walled carbon nanotubes. By lightly doped, it is meant to imply that the concentration of single walled carbon nanotubes in the liquid crystal material is less than one percent on a weight percentage basis.

The switching time and on/off transition voltage of the liquid crystal molecules are inversely dependent on the dielectric anisotropy. However, long-term reliability concerns prohibit using liquid crystal molecules with arbitrarily large anisotropy.

By incorporating a dopant material consisting of highly anisotropic constituents, the liquid crystal molecules are geometrically aligned. Thus, the switching speed and drive voltage may be enhanced.

Single wall carbon nanotubes have a very large dielectric anisotropy. The dielectric constant along the tube length direction is typically greater than 1000 times greater than that transverse to the tube axis because of the similar geometric anisotropy. Once mixed into liquid crystal materials, single wall carbon nanotubes align along the liquid crystal molecules, enhancing the dielectric anisotropy of the association.

Referring to FIG. 2, a projection display system 110 in accordance with an embodiment of the invention includes one or more imagers 10 (one shown in FIG. 2) that modulate impinging light to produce a projected composite, color optical image (herein called “the projected image”). The system 110 may be front or rear projection. The projection display system 110 includes a single imager 10, for purposes of simplifying the following description, although other projection systems that have multiple imagers may be alternatively used and are within the scope of the appended claims. The imager 10 may be any liquid crystal imager, including a liquid crystal-on-silicon imager or a high temperature polysilicon (HTPS) liquid crystal display.

In accordance with some embodiments of the invention, the projection display system 110 includes a light source 112 (a mercury lamp, light emitting diodes, or lasers, as examples) that produces a broad visible spectrum illumination beam that passes through an ultraviolet/infrared (UV/IR) filter 114 of the system 110. The light passing from the filter 114, in turn, passes through a rotating color wheel.

A filter 118 acts as a time-varying wavelength filter to allow certain wavelengths of light to pass therethrough at the appropriate times so that the filtered light may be modulated by the imager 10 to produce the projected image. The filter 118 may be a color wheel or an electronically tunable color filter, as two examples.

More specifically, in some embodiments of the invention, the projection display system 110 may be a shared color system, a system in which, for example, the imager 10 modulates red, followed by green, followed by blue light. Thus, the imager 10 is temporally shared to modulate different primary color beams.

As previously stated, the single imager configuration that is depicted in FIG. 2 is for purposes of example only. Thus, the projection display system 110 may be replaced by another projection display system, in other embodiments of the invention, such as a projection display system that includes three imagers, one for each primary color (red, green and blue, for example) of the projected image. As another example, in some embodiments of the invention, red, green and blue light may be temporally shared on an imager in a two imager display projection system. Therefore, many variations are possible and are within the scope of the appended claims.

Referring to FIG. 2, among its other components, the projection display system 110 includes homogenizing and beam shaping optics 120 that further shape and collimate the light that exits the filter 118, prepolarizes and directs the resultant beam to the polarizing beam splitter 122. The polarizing beam splitter (PBS) 122 separates the light from the filter 118 based on polarization. More specifically, assuming the single imager configuration described above, the polarizing beam splitter 122 directs the different color sub-bands of light (at different times) to the imager 10. Once modulated by the imager 10, the polarizing beam splitter 122 directs the modulated beam through projection lenses 123 for purposes of forming the projected image, indicated by diverging arrows.

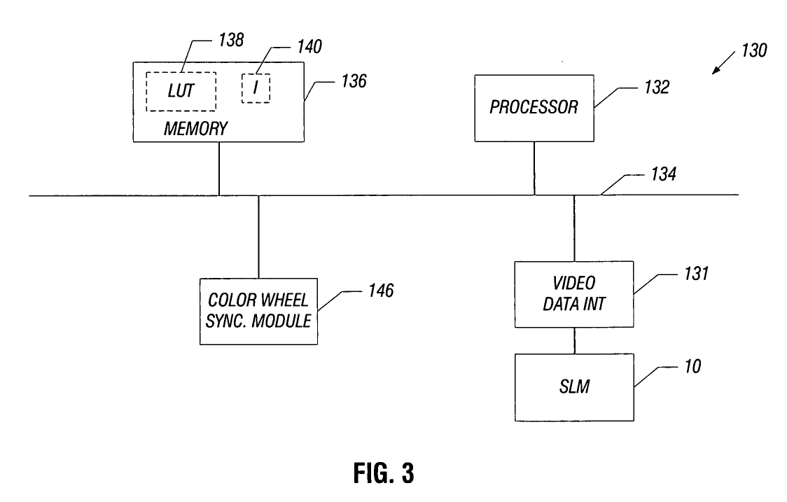

In some embodiments of the invention, an electrical system 130 for the projection display system 110 (FIG. 2) may have a general structure that is depicted in FIG. 3. Referring to FIG. 3, the electrical system 130 may include a processor 132 (one or more microcontrollers or microprocessors, as examples) that is coupled to a system bus 134. The processor 132 communicates over the system bus 134 with a memory 136 (a flash memory, for example) of the electrical system 130. The memory 136 stores instructions 140 to cause the processor 132 to perform one or more of the techniques that are described herein, as well as a look-up table (LUT) 138.

In some embodiments of the invention, the projection display system 110 (FIG. 2) operates the pixel cells of the imager 10 in a digital fashion, in that each pixel cell at any one time is either in a reflective state or a non-reflective state. Gray scale intensities are achieved by pulse width modulation (PWM), a modulation technique that controls the optical behavior of the pixel cell during an interval of time called a PWM cycle to control the intensity of the corresponding pixel of the projected image. The PWM control regulates the amount of time that a particular pixel cell is in its reflective and non-reflective states during a PWM cycle for purposes of establishing a certain pixel intensity. The amount of time that the pixel cell is in each reflectivity state for a given pixel intensity value is established by the LUT 138, in some embodiments of the invention. It is noted that in some embodiments of the invention, the LUT 138 may represent a collection of LUTS, one for each primary color. For purposes of simplifying the discussion herein, only one LUT is assumed, unless otherwise stated. The LUT 138 indicates a PWM duty cycle for each potential pixel intensity value.

Among its other features, the electrical system 130 may include a color wheel synchronization module 146 and a video data interface 131 that are coupled to the system bus 134. The color wheel synchronization module 146 serves to assist in ensuring that the physical position of the color wheel 118 is aligned with the start of a PWM timing cycle. The video data interface 131 receives pixel intensity data that is mapped through LUT 138 to specify per pixel PWM data (to drive the imager 10).

In some embodiments of the invention, the LUT 138 includes a corresponding duty cycle entry for each unique pixel intensity value. The duty cycle entry indicates a duration that the pixel cell remains in its default reflective state during the PWM cycle to produce the desired pixel intensity. The pixel cell remains in the non-default reflective state during the remainder of the PWM cycle. In some embodiments of the invention, each table entry indicates a number of pulse width modulation (PWM) counts, or clock cycles, for each intensity value. These are the number of clock cycles that the pixel cell needs to remain in its default reflective state. For the remaining clock cycles of the PWM cycle (having a fixed duration, for example), the pixel cell is in its non-default reflective state. The PWM clock counts may be executed with the non-reflective portion first and the reflective portion second or with the reflective portion first and the non-reflective portion second. In other embodiments, fractions of the total reflective and non-reflective clock counts may be alternated during a PWM cycle. In any execution strategy, the LUT-prescribed time proportion remains consistent relative to the whole PWM cycle time.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
forming an imager using a liquid crystal material doped with single walled carbon nanotubes.

2. The method of claim 1 including doping a liquid crystal material with single walled carbon nanotubes such that the carbon nanotubes amount to less than one percent of the liquid crystal material on a weight percentage basis.

3. The method of claim 1 including forming a liquid crystal-on-silicon imager.

4. The method of claim 1 including placing a transparent top electrode over said liquid crystal material.

5. The method of claim 4 including forming drive transistors in a back plane, and placing said liquid crystal material over said back plane.

6. A rear projection display comprising:
an imager including liquid crystal material doped with single walled carbon nanotubes; and
a polarizing beam splitter to receive light from said imager and to supply light to said imager.

7. The display of claim 6 including a lamp as the light source.

8. The display of claim 6 including one or more light emitting diodes as the light source.

9. The display of claim 6 including one or more lasers as the light source.

10. The display of claim 6 including a color wheel.

11. The display of claim 6 including an electrically tunable color filter.

12. The display of claim 6 including a projection lens.

13. The display of claim 6 wherein said single walled carbon nanotubes amount to less than one percent of said liquid crystal material on a weight percent.

14. The display of claim 6 wherein said liquid crystal material is covered by a transparent top electrode.

15. A method comprising:
using single walled carbon nanotubes in liquid crystal material to form images.

16. The method of claim 15 including using a liquid crystal material having less than one percent carbon nanotubes on a weight percentage basis.

17. The method of claim 15 including operating a liquid crystal-on-silicon imager.

18. The method of claim 15 including using said imager in a rear projection display.

19. The method of claim 15 including using said imager in a front projector.
